(19) United States
(12) Patent Application Publication
(10) Pub. No.: US 2026/0180229 A1
(43) Pub. Date: Jun. 25, 2026

(54) DC SOCKET

(71) Applicant: Schneider Electric Industries SAS, Rueil-Malmaison (FR)

(72) Inventors: Youliang ZHANG, Shenzhen (CN); Dahai ZHANG, Shenzhen (CN); Zhen MA, Shenzhen (CN)

(21) Appl. No.: 19/419,793

(22) Filed: Dec. 15, 2025

(30) Foreign Application Priority Data
Dec. 20, 2024 (CN) 202411896361.9

(51) Int. Cl. H01R 13/447; H01R 24/78; H01R 103/00

(52) U.S. Cl. CPC H01R 13/447; H01R 24/78; H01R 2103/00

(57) ABSTRACT

A DC socket includes: a bracket including a first through hole and a pair of second through holes; three socket contacts including a ground socket contact disposed at the first through hole and a pair of electrode socket contacts each disposed at the corresponding second through hole; and a protective shutter supported by the bracket and slidable between a first position and a second position along a first direction. The protective shutter includes a driving surface that is adapted to be driven by a ground pin, and the first direction is arranged at an angle with respect to width directions of a positive and negative pins, to enable the protective shutter to slide obliquely. When the protective shutter is in the first position, the driving surface is aligned with the first through hole to block through holes. When the protective shutter is in the second position, the through holes are exposed.

This application claims priority to Chinese Patent Application No. 202411896361.9, filed on Dec. 20, 2024, and entitled “DC SOCKET”, the entirety of which is incorporated herein by reference.

### FIELD

Embodiments of the present disclosure generally relate to the technical field of electrical equipment, and more particularly, to a DC socket.

### BACKGROUND

A protective shutter is disposed in a socket and is located between insertion holes and socket contacts of the socket. The protective shutter is configured to prevent foreign objects from being accidentally inserted into the socket contacts through the insertion holes, thereby avoiding the occurrence of electric shock accidents.

Protective shutters in conventional sockets are usually driven by a single pin to rotate. However, in a case where a positive pin and a negative pin for insertion into the socket are arranged perpendicular to each other, it is difficult to meet the requirements of a small-size design of the socket and the insertion of both the positive and negative pins. Thus, how to design a protective shutter that can be driven by a ground pin is an urgent technical problem to be solved currently.

### SUMMARY

In an aspect of the present disclosure, a DC socket is provided. the DC socket is adapted to mate with a ground pin, a positive pin, and a negative pin of a plug, and the DC socket includes: a bracket including a first through hole and a pair of second through holes; three socket contacts including a ground socket contact disposed at the first through hole and a pair of electrode socket contacts each disposed at the corresponding second through hole; and a protective shutter supported by the bracket and slidable relative to the bracket between a first position and a second position along a first direction, the protective shutter including a driving surface that is adapted to be driven by the ground pin, and the first direction is arranged at an angle with respect to a width direction of the positive pin and a width direction of the negative pin, to enable the protective shutter to slide obliquely, wherein when the protective shutter is in the first position, the driving surface is aligned with the first through hole to block the first through hole and the protective shutter blocks the pair of second through holes, and when the protective shutter is in the second position, the first through hole and the pair of second through holes are exposed by the protective shutter.

In some embodiments, the driving surface is arranged obliquely relative to an insertion direction of the ground pin, and an inclination direction of the driving surface is arranged at an angle with respect to the first direction.

In some embodiments, the bracket further includes a first sliding part extending along the first direction, and a side of the protective shutter adjacent to the bracket is mated with the first sliding part.

In some embodiments, the first sliding part includes sliding protrusions or sliding grooves arranged in pairs and spaced apart from each other.

In some embodiments, the bracket includes a pair of first sliding parts, each first sliding part includes a sliding protrusion, the side of the protective shutter adjacent to the bracket includes a sliding protrusion, and the sliding protrusion of the protective shutter is located between the pair of first sliding parts of the bracket.

In some embodiments, the DC socket further includes a covering member covering the protective shutter and the bracket and including a guide groove, the protective shutter further includes a main body and a second sliding part connected to the main body, and at least a portion of the second sliding part is located in the guide groove.

In some embodiments, the main body further includes a fourth through hole, when the protective shutter is in the first position, the fourth through hole is offset from one second through hole of the pair of second through holes, and when the protective shutter slides to the second position, the fourth through hole is aligned with the corresponding second through hole, to enable the corresponding second through hole to be exposed.

In some embodiments, the second sliding part includes a sliding surface facing away from the bracket, and the sliding surface is in contact with an inner surface of the guide groove.

In some embodiments, the second sliding part further includes a first side surface and a second side surface that are connected to the sliding surface, and at least a portion of the second side surface and at least a portion of the first side surface extend along the first direction and are in contact with the inner surface of the guide groove.

In some embodiments, the second sliding part further includes a third through hole adjacent to the driving surface, and the driving surface is disposed at a side of the third through hole along the first direction.

In some embodiments, the covering member further includes a mounting part and an elastic member, the mounting part is disposed at a side of the elastic member along the first direction, the mounting part is disposed in the guide groove, an end of the elastic member is connected to the mounting part, and the other end of the elastic member abuts against the protective shutter.

In some embodiments, the second sliding part further includes a mounting groove facing away from the bracket, and the other end of the elastic member abuts against an inner surface of the mounting groove.

In some embodiments, the elastic member includes a spring.

It should be understood that the content described in this section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, where:

FIG. 1 shows a schematic diagram of the mating between a DC socket and a plug according to some embodiments of the present disclosure;

FIG. 2 shows an exploded view of a bracket, a socket contact, a protective shutter, a covering member, and a base shown in FIG. 1;

FIG. 3 shows a schematic structural diagram of the bracket and the protective shutter shown in FIG. 1;

FIG. 4 shows an exploded view of the bracket and the protective shutter shown in FIG. 3;

FIG. 5 shows a schematic structural diagram of a covering member according to some embodiments of the present disclosure;

FIG. 6 shows a schematic structural diagram of a protective shutter and a covering member according to some embodiments of the present disclosure;

FIG. 7 shows an exploded view of a bracket and a protective shutter according to some other embodiments of the present disclosure; and

FIG. 8 shows a schematic structural diagram of a covering member according to some other embodiments of the present disclosure.

### DESCRIPTION OF REFERENCE NUMERALS

100 DC socket; 200 plug, 201 ground pin, 202 positive pin, 203 negative pin;
1 bracket, 11 first through hole, 12 second through hole, 13 first sliding part;
2 socket contact, 21 ground electrode socket contact, 22 electrode socket contact;
3 protective shutter, 31 main body, 311 fourth through hole, 32 second sliding part, 321 driving surface, 322 sliding surface, 323 third through hole, 324 mounting groove, 325 first side surface, 326 second side surface;
4 covering member, 41 guide groove, 42 mounting part, 43 elastic member, 44 first via;
5 cover plate, 51 second via;
6 base;
X first direction; Y inclination direction of driving surface, Z1 width direction of positive pin, Z2 width direction of negative pin.

### DETAILED DESCRIPTION

Embodiments of the present disclosure will be described in more detail below with reference to the accompanying drawings. While embodiments of the present disclosure are shown in the drawings, it should be understood that the present disclosure may be implemented in various forms and should not be limited by embodiments set forth herein. Rather, these embodiments are provided to make this disclosure more thorough and complete, and to fully convey the scope of the present disclosure to those skilled in the art.

As used herein, the term “including” and variations thereof represent openness, i.e., “including but not limited to”. Unless specifically stated, the term “or” means “and/or”. The term “based on” means “based at least in part on”. The terms “an example embodiment” and “an embodiment” mean “at least one example embodiment”. The term “another embodiment” means “at least one further embodiment”. The terms “first”, “second”, and the like may refer to different or identical objects.

As described above, protective shutters in conventional sockets are usually driven by a single electrode pin to rotate. However, in a case where a positive pin and a negative pin for insertion into the socket are arranged perpendicular to each other, a through hole corresponding to the positive pin and a through hole corresponding to the negative pin are perpendicular to each other. The inventor has noted that if it is desired to reduce the size of the socket, it is also necessary to shorten the stroke of the protective shutter. On this basis, if the protective shutter slides along an opening direction of any through hole, at least one of the through hole corresponding to the positive pin and the through hole corresponding to the negative pin may fail to be exposed, resulting in at least one of the positive pin and the negative pin failing to be inserted smoothly. Nevertheless, increasing the stroke of the protective shutter can resolve the problem that the through holes cannot be exposed, but this is not conducive to the small-size design of the socket.

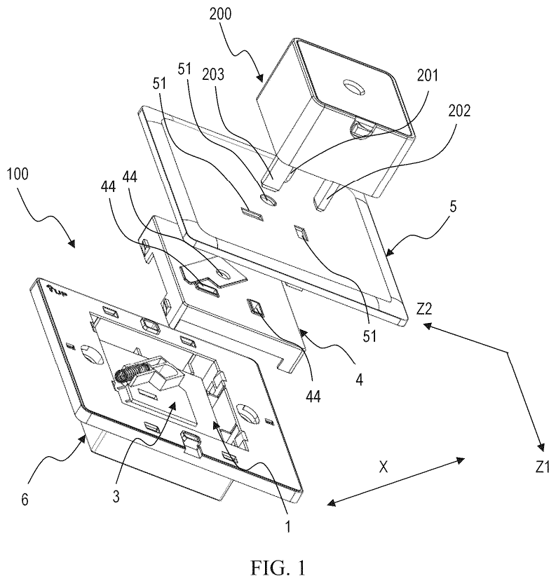

Based on this, embodiments of the present disclosure provide a DC socket 100 to at least partially solve the above problems. Hereinafter, the principles of the present disclosure will be described with reference to FIGS. 1 to 8.

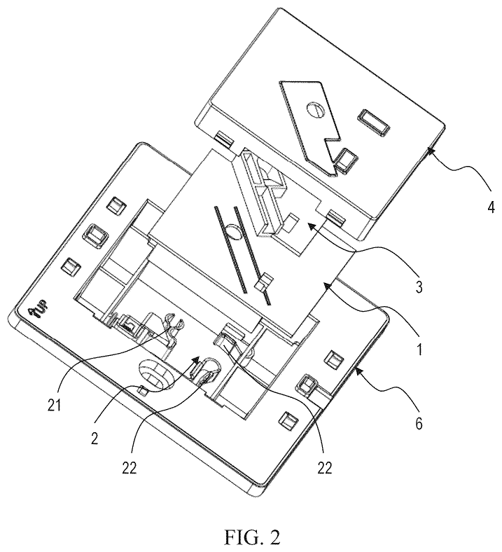

FIG. 1 shows a schematic diagram of the mating between a direct current, DC, socket 100 and a plug 200 according to some embodiments of the present disclosure. FIG. 2 shows an exploded view of a bracket 1, socket contacts 2, a protective shutter 3, a covering member 4, and a base 6 shown in FIG. 1. As shown in FIGS. 1 to 2, the DC socket 100 described herein generally includes the bracket 1, the socket contacts 2, the protective shutter 3, the covering member 4, a cover plate 5, and the base 6. The DC socket 100 may mate with a ground pin 201, a positive pin 202, and a negative pin 203 of the plug 200, and the positive pin 202 and the negative pin 203 are disposed perpendicular to each other.

As shown in FIG. 1, in some embodiments, the cover plate 5 may cover the base 6 and be assembled to the base 6, and the cover plate 5 may further cover the bracket 1, three socket contacts 2, the protective shutter 3, and the covering member 4 to achieve a protective function. As shown in FIG. 2, the covering member 4 may cover the protective shutter 3 and the bracket 1, and the covering member 4 may be connected to the base 6 after being inserted into the base 6. In this way, the bracket 1, the socket contacts 2, the protective shutter 3, the covering member 4, the cover plate 5, and the base 6 may be fixed as a whole.

With continued reference to FIG. 1, in some embodiments, the cover plate 5 may include three second vias 51, which can be used for the insertion of corresponding pins. The covering member 4 may include three first vias 44, which may also be used for the insertion of corresponding pins. The three vias 51 are each aligned with the corresponding first vias 44, so that after being inserted into the corresponding second vias 51, the pins can be further inserted into the corresponding first vias 44, thereby enabling the pins to pass through the cover plate 5 and the covering member 4 in sequence.

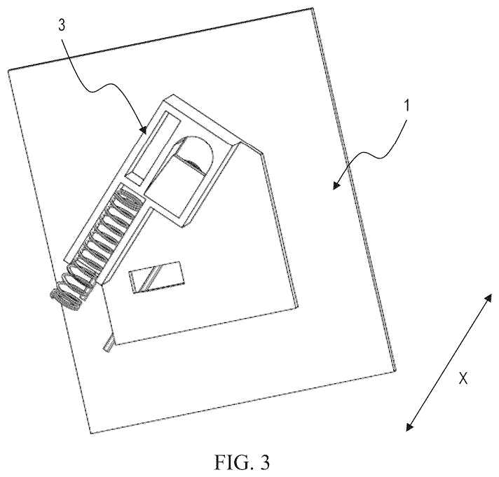

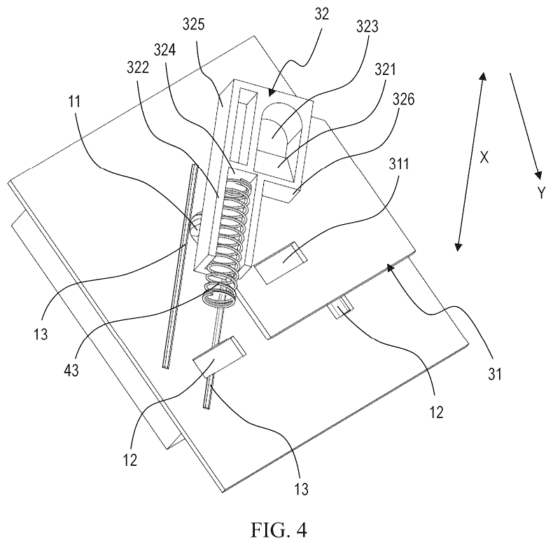

FIG. 3 shows a schematic structural diagram of the bracket 1 and the protective shutter 3 shown in FIG. 1. FIG. 4 shows an exploded view of the bracket 1 and the protective shutter 3 shown in FIG. 3. As shown in FIGS. 1 to 4, in some embodiments, the bracket 1 may include a first through hole 11 and a pair of second through holes 12. The three socket contacts 2 are covered by a bracket 1 and include a ground pocket 21 and a pair of electrode socket contacts 22. The ground socket contact 21 is disposed at the first through hole 11, and the pair of electrode socket contacts 22 are each disposed at the corresponding second through hole 12. The protective shutter 3 is supported by the bracket 1, and the protective shutter 3 is slidable relative to the bracket 1 between a first position and a second position along the first direction X. The protective shutter 3 includes a driving surface 321. The driving surface 321 is aligned with the corresponding first via 44. Therefore, during the process in which the ground pin 201 is inserted into the corresponding first via 44, the driving surface 321 can be driven by the ground pin 201. The first direction X is disposed at an angle with respect to a width direction Z1 of the positive pin 202 and a width direction Z2 of the negative pin 203. Therefore, the protective shutter 3 can slide obliquely under the driving of the ground pin 201.

Since the driving surface 321 is aligned with the corresponding first via 44, during the process in which the ground pin 201 is inserted into the corresponding first via 44, the ground pin 201 can press the driving surface 321 and cause the protective shutter 3 to slide obliquely along the first direction X.

In addition, when the protective shutter 3 is in the first position, the driving surface 321 is aligned with the first through hole 11 to block the first through hole 11, and the protective shutter 3 blocks the pair of second through holes 12. When the protective shutter 3 is in the second position, the first through hole 11 and the pair of second through holes 12 are exposed by the protective shutter 3. Thus, the positive pin 202 and the negative pin 203 can pass through the corresponding second through holes 12 to draw power from the corresponding electrode socket contacts 22.

According to embodiments of the present disclosure, since the first direction X in which the protective shutter 3 slides is disposed at an angle with respect to the width direction Z1 of the positive pin 202 and the width direction Z2 of the negative pin 203, and the driving surface 321 can be driven by the ground pin 201, the protective shutter 3 can slide obliquely under the driving of the ground pin 201. With the above configuration, compared with the solution in which the protective shutter 3 slides along the width direction Z1 of the positive pin 202 or the width direction Z2 of the negative pin 203, the stroke of the protective shutter 3 of the DC socket 100 according to embodiments of the present disclosure in the DC socket 100 is shortened, thereby realizing a small-size design of the DC socket 100 and ensuring that the pair of second through holes 12 are smoothly exposed. Therefore, both the positive pin 202 and the negative pin 203 can be smoothly inserted into the corresponding second through holes 12.

With continued reference to FIGS. 1 and 4, in some embodiments, the driving surface 321 may be arranged obliquely relative to an insertion direction of the ground pin 201, and an inclination direction Y of the driving surface 321 may be arranged at an angle with respect to the first direction X. Thus, in a case where the ground pin 201 presses the driving surface 321, the protective shutter 3 can slide along the first direction X under the action of the component force of the pressing force exerted by the ground pin 201 on the driving surface 321.

With continued reference to FIGS. 3 and 4, in some embodiments, the bracket 1 may further include a first sliding part 13 extending along the first direction X. A side of the protective shutter 3 adjacent to the bracket 1 is mated with the first sliding part 13. Thus, when the protective shutter 3 is driven, the protective shutter 3 can slide on the first sliding part 13. With continued reference to FIGS. 3 and 4, the first sliding part 13 may include a sliding protrusion or a sliding groove. The sliding protrusion or the sliding groove can be arranged in pairs, thereby improving the smoothness of the sliding of the protective shutter 3. In addition, the sliding protrusions or sliding grooves may be spaced apart from each other to reduce the frictional forces that the protective shutter 3 is subjected to during its sliding. Certainly, the sliding protrusions or the sliding grooves may be connected to each other.

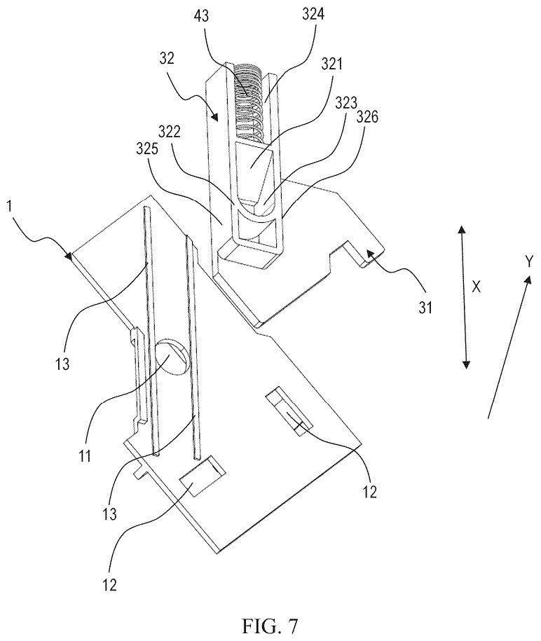

Further, with continued reference to FIGS. 3 and 4, along the insertion direction of the plug 200, the driving surface 321 may be disposed adjacent to the first sliding part 13. It can be understood that, since a single position of the protective shutter is subjected to force, by arranging the single force-bearing position of the protective shutter 3 adjacent to a sliding position of the protective shutter 3, the protective shutter 3 can slide smoothly under force, thereby avoiding the problem that the protective shutter 3 tilts, overturns or even gets jammed and thus fails to slide due to the force-bearing position deviating from the sliding position. Alternatively, in an example shown in FIG. 7, along the insertion direction of the plug 200, the driving surface 321 may be arranged to partially overlap with the first sliding part 13, so as to enable the protective shutter 3 to slide smoothly. Of course, in a case where the driving surface 321 completely overlaps the first sliding part 13, the smoothness of the sliding of the protective shutter 3 is significantly improved.

Hereinafter, the principle of the present disclosure will be mainly illustratively described by taking the first sliding part 13 including the sliding protrusion as an example. The case in which the first sliding part 13 includes the sliding groove is similar, as long as it can enable the protective shutter 3 to slide on the first sliding part 13, and details will not be repeated herein.

With continued reference to FIGS. 3 and 4, in some embodiments, a side of the protective shutter 3 adjacent to the bracket 1 may be a flat plane. Therefore, the protective shutter 3 can slide on the first sliding part 13. In some other embodiments, the side of the protective shutter 3 adjacent to the bracket 1 may include a sliding protrusion, and the sliding protrusion of the protective shutter 3 may be located between the pair of first sliding parts 13. Therefore, the protective shutter 3 may also slide on the first sliding part 13.

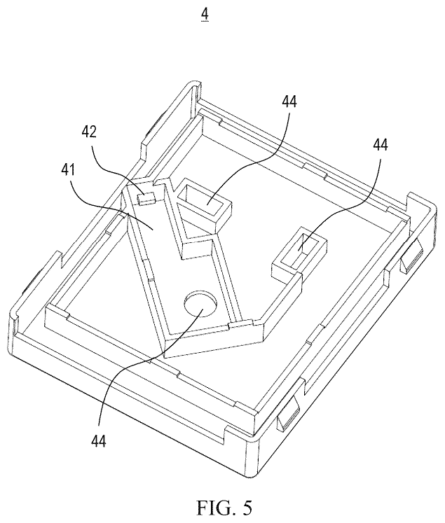

FIG. 5 shows a schematic structural diagram of the covering member 4 according to some embodiments of the present disclosure. As shown in FIG. 5, the covering member 4 may include a guide groove 41, and the guide groove 41 may provide a sliding space for the protective shutter 3 and guide the sliding of the protective shutter 3. Referring back to FIG. 4, the protective shutter 3 may further include a main body 31 and a second sliding part 32 connected to the main body 31, and at least a portion of the second sliding part 32 may be located in the guide groove 41. Therefore, the protective shutter 3 can slide in the guide groove 41.

In addition, referring back to FIG. 4, the main body 31 may further include a fourth through hole 311, and when the protective shutter 3 is in the first position, the fourth through hole 311 may be offset from one second through hole 12 of the pair of second through holes 12. When the protective shutter 3 slides to the second position, the fourth through hole 311 may be aligned with the corresponding second through hole 12, to enable the corresponding second through hole 12 to be exposed.

Referring back to FIG. 4, in some embodiments, the second sliding part 32 may further include a third through hole 323. The third through hole 323 may be adjacent to the driving surface 321, and the driving surface 321 is disposed at a side of the third through hole 323 along the first direction X. In this way, when the protective shutter 3 is driven by the ground pin 201 to slide along the first direction X, the third through hole 323 can slide to a position where it is aligned with the first through hole 11, so that the ground pin 201 can pass through the third through hole 323 and the first through hole 11 in sequence, and further be inserted into the ground socket contact 21.

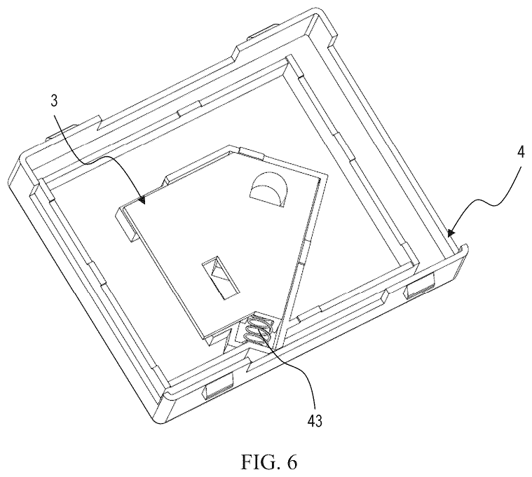

FIG. 6 shows a schematic structural diagram of the protective shutter 3 and the covering member 4 according to some embodiments of the present disclosure. As shown in FIGS. 4 to 6, in some embodiments, the second sliding part 32 may include a sliding surface 322 facing away from the bracket 1. The sliding surface 322 may be in contact with an inner surface of the guide groove 41. With the above configuration, on the premise that the side of the protective shutter 3 adjacent to the bracket 1 is in contact with the first sliding part 13, since the sliding surface 322 is also in contact with the inner surface of the guide groove 41, the upper end surface and the lower end surface of the protective shutter 3 are respectively in contact with the covering member 4 and the bracket 1, so as to improve the smoothness of the sliding of the protective shutter 3.

Referring to FIGS. 4 to 6, in some embodiments, the second sliding part 32 may further include a first side surface 325 and a second side surface 326. The first side surface 325 and the second side surface 326 are respectively connected to the sliding surface 322, and the first side surface 325 and the second side surface 326 are closer to the bracket 1 than the sliding surface 322. At least a portion of the second side surface 326 and at least a portion of the first side surface 325 may extend along the first direction X and are in contact with the inner surface of the guide groove 41. Thus, two sides of the protective shutter 3 can be in contact with the inner surface of the guide groove 41 to guide the protective shutter 3 to slide along the first direction X.

With continued reference to FIGS. 4 to 6, in some embodiments, the covering member 4 may further include a mounting part 42 and an elastic member 43. The mounting part 42 may be disposed at a side of the elastic member 43 along the first direction X, and the mounting part 42 and the elastic member 43 may respectively extend along the first direction X. The mounting part 42 may be disposed in the guide groove 41, an end of the elastic member 43 may be connected to the mounting part 42, and the other end of the elastic member 43 may abut against the protective shutter 3. With the above configuration, during the process in which the protective shutter 3 is driven by the ground pin 201 to slide along the first direction X, since two ends of the elastic member 43 are respectively blocked by the mounting part 42 and the protective shutter 3, the elastic member 43 can be compressed and store energy. When the local pole pin 201 is pulled out from the DC socket 100, the elastic member 43 can return the protective shutter 3 to the first position.

Further, with continued reference to FIGS. 4 to 6, the second sliding part 32 may further include a mounting groove 324 facing away from the bracket 1, and the other end of the elastic member 43 abuts against an inner surface of the mounting groove 324. With the above configuration, since the other end of the elastic member 43 can be blocked by the mounting groove, during the process in which the protective shutter 3 is driven by the ground pin 201 to slide along the first direction X, the elastic member 43 can be compressed and store energy

In addition, the mounting groove 324 may extend along the first direction X, and a cross-sectional area of the mounting part 42 taken by a cross-section perpendicular to the first direction X may be smaller than a cross-sectional area of the mounting groove 324. Therefore, when the sliding path of the protective shutter 3 is relatively long, the mounting part 42 can be located in the mounting groove 324 to avoid interfering with the sliding of the protective shutter 3.

It should be noted that, in some other embodiments, as an alternative to the above solution, the mounting part 42 may be disposed on the bracket 1, and the mounting groove 324 may be located at a side of the protective shutter 3 away from the bracket 1. An end of the elastic member 43 may be connected to the mounting part 42, and the other end of the elastic member 43 may abut against the inner surface of the mounting groove 324. With the above configuration, the elastic member 43 can also return the protective shutter 3 to the first position, which will not be repeated herein.

The elastic member 43 according to embodiments of the present disclosure may be various types of elastic members 43 currently known or available in the future, which is not limited by embodiments of the present disclosure. For example, in some embodiments, the elastic member 43 may be a spring.

FIG. 7 shows an exploded view of the bracket 1 and the protective shutter 3 according to some other embodiments of the present disclosure. The protective shutter 3 shown in FIG. 7 has a similar structure as the protective shutter 3 shown in FIG. 4, the main differences lie in that the sliding direction of the protective shutter 3 in FIG. 7 is opposite to the sliding direction of the protective shutter 3 in FIG. 4, the structure of the main body 31, and the structure of the second sliding part 32. Hereinafter, the difference between the two will be mainly described, and the same parts will not be repeated herein.

Referring to FIG. 7, the main body 31 is not provided with the fourth through hole 311. Thus, when the protective shutter 3 is in the first position, the main body 31 blocks the pair of second through holes 12, and in the case where the protective shutter 3 slides to the second position, the main body 31 may be offset from the pair of second through holes 12.

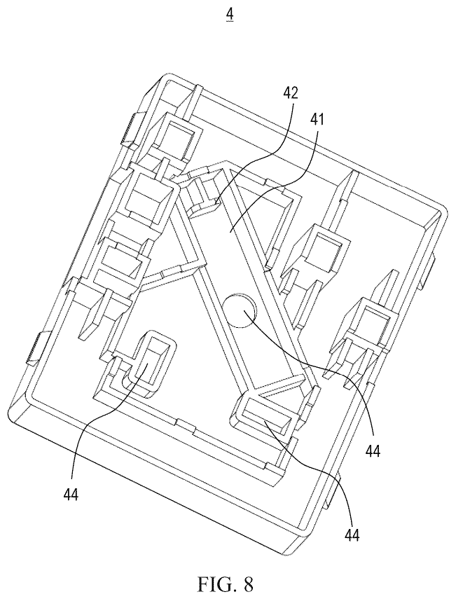

FIG. 8 shows a schematic structural diagram of the covering member 4 according to some other embodiments of the present disclosure. As shown in FIGS. 7 to 8, the second side surface 326 and the first side surface 325 are parallel to each other, and the second side surface 326 and the first side surface 325 may extend along the first direction X and be in contact with the inner surface of the guide groove 41. Thus, two sides of the protective shutter 3 can be in contact with the inner surface of the guide groove 41 to guide the protective shutter 3 to slide along the first direction X.

According to embodiments of the present disclosure, since the first direction in which the protective shutter slides is disposed at an angle with respect to the width direction of the positive pin and the width direction of the negative pin, and the driving surface can be driven by the ground pin, the protective shutter can slide obliquely under the driving of the ground pin. With the above configuration, compared with the solution in which the protective shutter slides along the width direction of the positive pin or the width direction of the negative pin, the stroke of the protective shutter of the DC socket according to embodiments of the present disclosure in the DC socket is shortened, thereby realizing a small-size design of the DC socket and ensuring that the pair of second through holes are smoothly exposed.

The design of the protective shutter according to embodiments of the present disclosure may be applied to various DC socket to at least partially solve the above problems. It should be understood that the design of the protective shutter according to embodiments of the present disclosure may also be applied to other components, which is not limited by embodiments of the present disclosure.

Various embodiments of the present disclosure have been described above, which are illustrative, not exhaustive, and are not limited to embodiments disclosed. Many modifications and variations will be apparent to those of ordinary skill in the art without departing from the scope and spirit of the illustrated embodiments. The selection of the terms used herein is intended to explain the principles of embodiments, practical applications, or technical improvements in the marketplace, or to enable others of ordinary skill in the art to understand the embodiments disclosed herein.

1. A DC socket, wherein the DC socket is adapted to mate with a ground pin, a positive pin, and a negative pin of a plug, and the DC socket comprises:
a bracket comprising a first through hole and a pair of second through holes;
three socket contacts comprising a ground socket contact disposed at the first through hole and a pair of electrode socket contacts each disposed at the corresponding second through hole; and
a protective shutter supported by the bracket and slidable relative to the bracket between a first position and a second position along a first direction, the protective shutter comprising a driving surface adapted to be driven by the ground pin, and the first direction is arranged at an angle with respect to a width direction of the positive pin and a width direction of the negative pin, to enable the protective shutter to slide obliquely,
wherein when the protective shutter is in the first position, the driving surface is aligned with the first through hole to block the first through hole and the protective shutter blocks the pair of second through holes, and when the protective shutter is in the second position, the first through hole and the pair of second through holes are exposed by the protective shutter.

2. The DC socket of claim 1, wherein the driving surface is arranged obliquely relative to an insertion direction of the ground pin, and an inclination direction of the driving surface is arranged at an angle with respect to the first direction.

3. The DC socket of claim 1, wherein the bracket further comprises a first sliding part extending along the first direction, and a side of the protective shutter adjacent to the bracket is mated with the first sliding part.

4. The DC socket of claim 3, wherein the first sliding part comprises sliding protrusions or sliding grooves arranged in pairs and spaced apart from each other.

5. The DC socket of claim 3, wherein the bracket comprises a pair of first sliding parts, each first sliding part comprises a sliding protrusion, the side of the protective shutter adjacent to the bracket comprises a sliding protrusion, and the sliding protrusion of the protective shutter is located between the pair of first sliding parts of the bracket.

6. The DC socket of claim 3, wherein the DC socket further comprises a covering member covering the protective shutter and the bracket and comprising a guide groove, the protective shutter further comprises a main body and a second sliding part connected to the main body, and at least a portion of the second sliding part is located in the guide groove.

7. The DC socket of claim 6, wherein the main body further comprises a fourth through hole, when the protective shutter is in the first position, the fourth through hole is offset from one second through hole of the pair of second through holes, and when the protective shutter slides to the second position, the fourth through hole is aligned with the corresponding second through hole, to enable the corresponding second through hole to be exposed.

8. The DC socket of claim 6, wherein the second sliding part comprises a sliding surface facing away from the bracket, and the sliding surface is in contact with an inner surface of the guide groove.

9. The DC socket of claim 8, wherein the second sliding part further comprises a first side surface and a second side surface that are connected to the sliding surface, and at least a portion of the second side surface and at least a portion of the first side surface extend along the first direction and are in contact with the inner surface of the guide groove.

10. The DC socket of claim 6, wherein the second sliding part further comprises a third through hole adjacent to the driving surface, and the driving surface is disposed at a side of the third through hole along the first direction.

11. The DC socket of claim 6, wherein the covering member further comprises a mounting part and an elastic member, the mounting part is disposed at a side of the elastic member along the first direction, the mounting part is disposed in the guide groove, an end of the elastic member is connected to the mounting part, and the other end of the elastic member abuts against the protective shutter.

12. The DC socket of claim 11, wherein the second sliding part further comprises a mounting groove facing away from the bracket, and the other end of the elastic member abuts against an inner surface of the mounting groove.

13. The DC socket of claim 11, wherein the elastic member comprises a spring.

14. A DC socket adapted for receiving a plug, the DC socket comprising:
a bracket comprising a ground pin through hole, a negative pin through hole and a positive pin through hole; wherein the negative pin through hole and the positive pin through hole have rectangular shapes with respective first dimensions that are longer than their respective second dimensions, the respective first dimensions being non-parallel to each other;
a ground socket contact disposed at the ground pin through hole, a negative socket contact disposed at the negative pin through hole and a positive socket contact disposed at the positive pin through hole; and
a protective shutter slidably disposed on a surface of the bracket and slidable between a first position and a second position along a first direction that is oblique relative to the respective first dimensions, the protective shutter comprising a driving surface that is inclined relative to the surface of the bracket;
wherein when the protective shutter is in the first position, the driving surface covers the ground pin through hole to prevent pin access therethrough, and the protective shutter covers at least one of the negative pin through hole and the positive pin through hole to prevent pin access therethrough; and wherein when the protective shutter is in the second position, the driving surface uncovers the ground pin through hole to allow pin access therethrough, and the the protective shutter uncovers the at least one of the negative pin through hole and the positive pin through hole to allow pin access therethrough.

15. The DC socket of claim 14, further comprising a biasing member that exerts a force urging the protective shutter to the first position.

16. The DC socket of claim 14, wherein the bracket further comprises a first sliding part extending along the first direction, and a side of the protective shutter adjacent to the bracket is mated with the first sliding part.

17. The DC socket of claim 16, wherein the first sliding part comprises sliding protrusions or sliding grooves arranged in pairs and spaced apart from each other.

18. A DC socket adapted for receiving a plug, the DC socket comprising:
a bracket comprising a plurality of through holes including a ground pin through hole, a negative pin through hole and a positive pin through hole;
a plurality of socket contacts, wherein a respective one of the plurality of socket contacts is registered with a respective one of the plurality of through holes;
a protective shutter slidably disposed on a surface of the bracket and slidable between a first position and a second position along a first direction that is oblique relative to respective long dimensions of the plurality of through holes, the protective shutter comprising a driving surface; and
a biasing member that exerts a force urging the protective shutter to the first position;
wherein the driving surface is inclined relative to the surface of the bracket such that a penetrating force impinging on the driving surface urges the protective shutter from the first position in which the protective shutter covers the plurality of through holes to the second position in which the protective shutter uncovers plurality of through holes.

19. The DC socket of claim 14, wherein the bracket further comprises a first sliding part extending along the first direction, and a side of the protective shutter adjacent to the bracket is mated with the first sliding part.

20. The DC socket of claim 16, wherein the bracket and the protective shutter define a sliding interface comprising rails and grooves dimensioned to receive the rails.
